(19) United States
(12) Patent Application Publication
(10) Pub. No.: US 2024/0187069 A1
(43) Pub. Date: Jun. 6, 2024

(54) ASSOCIATING BEAM INDICATION WITH A CHANNEL STATE INFORMATION (CSI) MEASUREMENT OR REPORT

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/551,575

(22) PCT Filed: May 27, 2021
(86) PCT No.: PCT/CN2021/096253

§ 371 Date: Sep. 20, 2023

(51) Int. Cl. H04B 7/06; H04W 16/28; H04W 72/1273; H04W 72/232; H04W 76/20

(52) U.S. Cl. CPC H04B 7/0626; H04W 16/28; H04W 72/1273; H04W 72/232; H04W 76/20

(57) ABSTRACT

Aspects of the present disclosure provide systems and methods for associating beam indication with a channel state information (CSI) measurement or CSI measurement and reporting. In addition, this disclosure provides CSI processing unit (CPU) occupancy rule for CSI triggered by beam indication, such that a user equipment (UE) may determine a start time for CPU occupancy. For example, a network entity may transmit signaling to a UE to associate at least one beam with a CSI measurement or report in the UE. The network entity may transmit a beam indication to the UE for triggering the UE to perform CSI measurement or CSI measurement and reporting associated with the indicated beam.

### INTRODUCTION

Aspects of the present disclosure relate to wireless communications, and more particularly, to channel state information (CSI) feedback.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communication by a network entity. The method generally includes transmitting signaling to a user equipment (UE) to associate at least one beam with a channel state information (CSI) measurement or report in the UE; and transmitting a beam indication to the UE for triggering the UE to perform CSI measurement or CSI measurement and reporting associated with the beam.

Another aspect provides a method for wireless communication by a user equipment (UE). The method generally includes receiving signaling from a network entity associating at least one beam with a channel state information (CSI) measurement or report in the UE; receiving a beam indication from the network entity; and performing at least one of a CSI measurement or CSI measurement and reporting associated with a beam indicated by the beam indication.

One aspect provides an apparatus for wireless communication by a user equipment (UE). The apparatus includes a memory and a processor. The memory and the processor are configured to receive signaling from a network entity associating at least one beam with a channel state information (CSI) measurement or report in the UE; receive a beam indication from the network entity; and perform at least one of a CSI measurement or CSI measurement and reporting associated with a beam indicated by the beam indication.

Another aspect provides a non-transitory computer readable medium storing instructions that when executed by a user equipment (UE) cause the UE to: receive signaling from a network entity associating at least one beam with a channel state information (CSI) measurement or report in the UE; receive a beam indication from the network entity; and perform at least one of a CSI measurement or CSI measurement and reporting associated with a beam indicated by the beam indication.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE FIGURES

The appended figures depict certain features of the various aspects described herein and are not to be considered limiting of the scope of this disclosure.

FIG. 1 is a block diagram conceptually illustrating an example telecommunications system, in accordance with certain aspects of the present disclosure.

FIG. 2 is a block diagram conceptually illustrating a design of an example a base station (BS) and user equipment (UE), in accordance with certain aspects of the present disclosure.

FIGS. 3A-3D illustrate example frame formats for new radio (NR), in accordance with certain aspects of the present disclosure.

FIG. 4 is an example framework for a dynamic channel state information (CSI) report configuration.

FIG. 5 is an example timeline of a network entity transmitting a beam indication and a channel state information (CSI) measurement to a UE, in aspects associated with the present disclosure.

FIG. 6 is an example timeline for CSI processing unit (CPU) occupancy, in accordance with certain aspects of the present disclosure.

FIG. 7 is a flow diagram illustrating example operations for wireless communication by a UE, in accordance with certain aspects of the present disclosure.

FIG. 8 is a flow diagram illustrating example operations for wireless communication by a network entity, in accordance with certain aspects of the present disclosure.

FIG. 9 is an example configuration . . .

FIG. 10 is an example configuration . . .

FIG. 11 is an example timeline for CSI processing unit (CPU) occupancy, in accordance with certain aspects of the present disclosure

FIG. 12 illustrates a communications device that may include various components configured to perform operations for the techniques disclosed herein in accordance with aspects of the present disclosure.

FIG. 13 illustrates a communications device that may include various components configured to perform operations for the techniques disclosed herein in accordance with aspects of the present disclosure.

### DETAILED DESCRIPTION

Aspects of the present disclosure provide systems and methods for associating beam indication with a channel state information (CSI) measurement or CSI measurement and reporting. In addition, this disclosure provides CSI processing unit (CPU) occupancy rule for CSI triggered by beam indication, such that a user equipment (UE) may determine a start time for CPU occupancy. For example, a network entity may transmit signaling to a UE to associate at least one beam with a CSI measurement or report in the UE. The network entity may transmit a beam indication to the UE for triggering the UE to perform CSI measurement or CSI measurement and reporting associated with the indicated beam.

Development efforts aim to facilitate advanced beam refinement or tracking. Some examples of such development efforts include, for instance, triggering beam measurement, reporting, refinement, and/or selection using beam indication without CSI request. In examples, beam selection or activation may be based on beam measurement without beam indication or activation from the network. In some examples, synchronization signal block (SSB) may be group to reduce beam training. In some examples, aperiodic beam measurement or reporting may be based on multiple resource sets for reducing beam measurement latency. The present disclosure provides techniques for associating beam indication with CSI measurement or reporting, and furthers the development of one or more such techniques for beam refinement or tracking.

In certain systems, such as new radio (NR) systems, a UE is configured with N non-zero power (NZP) CSI reference signal (CSI-RS) resources for channel measurement (CMRs). The UE is configured to select one resource out of the configured N resources. The UE is also configured with CSI-RS resources for interference measurement (CSI-IMRs). The resources for interference measurement are associated with the configured resources for channel measurement. This CSI framework allows dynamic channel/interference hypothesis, for example, in the case of transmission by a single transmission reception point (TRP) or multiple TRPs.

In order to allow the TRP to have the flexibility to change or refine a beam with a UE in cases of multiple-UEs transmission, interference coordination, and channel reciprocity, the TRP may send beam indications to the UE to inform the UE which beams are used for data transmission, to allow the UE to use the corresponding proper receive beam for data reception. Such beam indication may trigger CSI measurement or CSI measurement and report, yet existing art does not clearly associate a beam indication with a CSI measurement or CSI measurement and report and does not specify when a UE may apply the CSI measurement or CIS measurement and report based on the beam indication. The present disclosure provides multiple options for associating a beam indication with a CSI measurement or CSI measurement and reporting.

When aperiodic CSI (A-CSI) is triggered via uplink (UL) related downlink control information (DCI), CSI measurement or CSI measurement and report is often not flexible or at least less flexible than CSI measurement or CSI measurement and report related to downlink (DL) DCI. For example, more DCI format (e.g., UL DCI 0-1, DL DCI 1-1, etc.) may be used to allow CSI to be transmitted on reserved UL: resource, not necessarily on dynamically scheduled PUSCH. In addition, CSI can be measured or calculated based on DMRS (e.g., may be more efficient than using CSI-RS for enabling a fast timeline). In some cases, CSI measurement or CSI measurement and report is enabled to enhance rate-control for high-Doppler scenarios. However, the CSI measurement or CSI measurement and report requires CSI processing units (CPUs) allocated for calculation. The present disclosure also provides techniques or schemes for configuring a start time for CPU occupancy in the UE.

The following description provides examples of associating beam indication with CSI measurement or CSI measurement and reporting, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method, which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

### Brief Introduction to Wireless Communication Networks

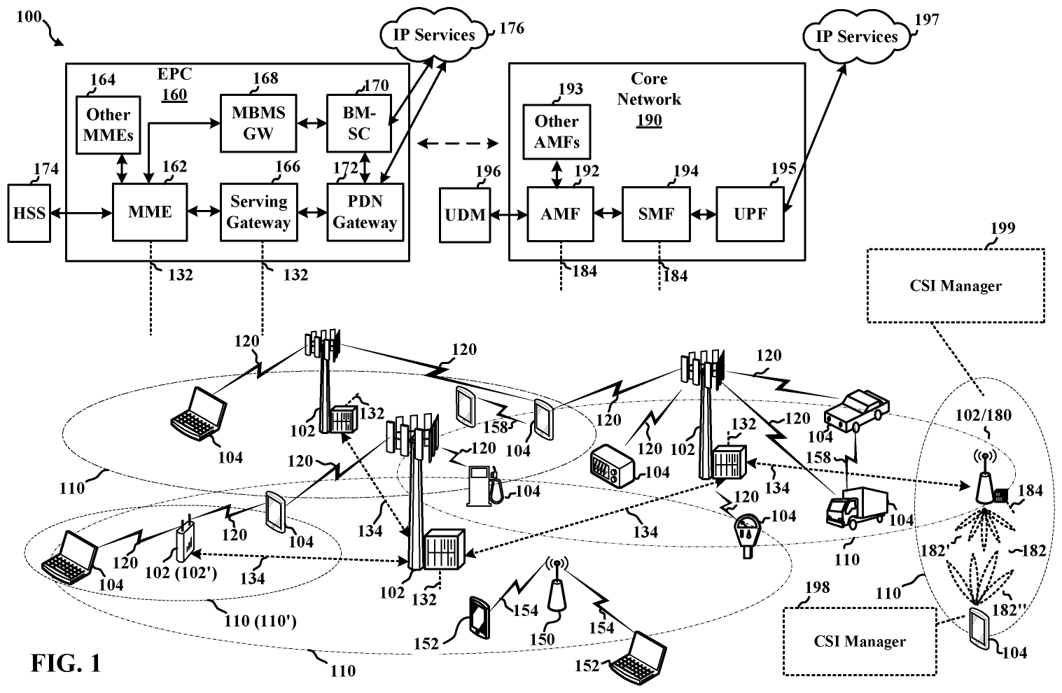

FIG. 1 depicts an example of a wireless communications system 100, in which aspects described herein may be implemented. While FIG. 1 is briefly introduced here for context, additional aspects of FIG. 1 are described below.

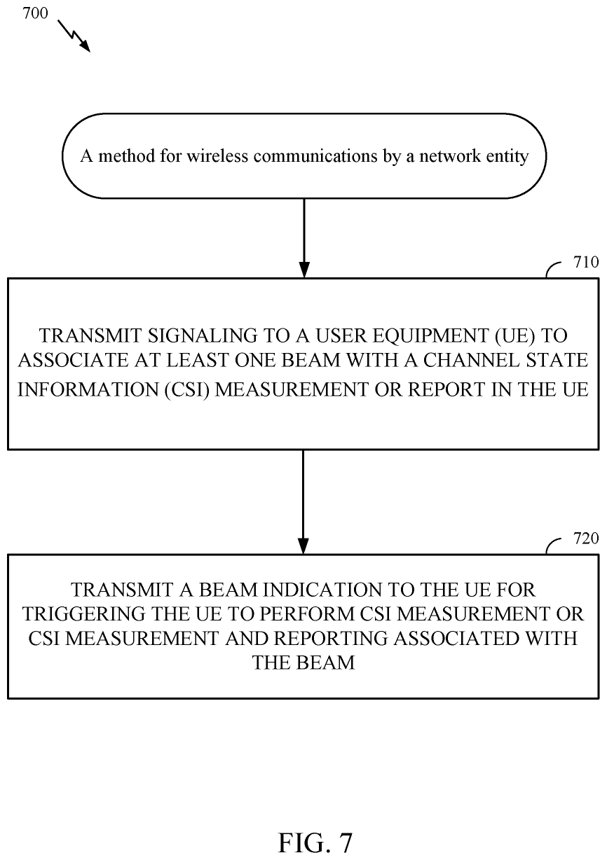

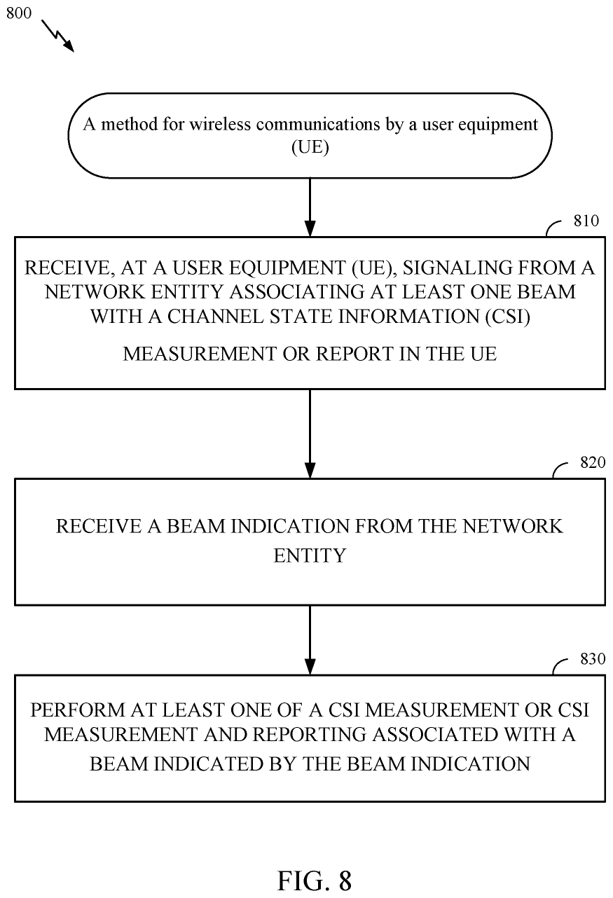

For example, wireless communication network 100 may include channel state information (CSI) manager 199, which may be configured to perform, or cause a base station (BS) 102 to perform, operations 700 of FIG. 7. Wireless communication network 100 may also include CSI manager 198, which may be configured to perform, or cause a user equipment (UE) 104 to perform, operations 800 of FIG. 8.

Generally, wireless communications system 100 includes BSs 102, UEs 104, one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. BSs 102 may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

BSs 102 wirelessly communicate with UEs 104 via communications links 120. Each of BSs 102 may provide communication coverage for a respective geographic coverage area 110, which may overlap in some cases. For example, small cell 102′ (e.g., a low-power BS) may have a coverage area 110′ that overlaps the coverage area 110 of one or more macrocells (e.g., high-power BSs).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

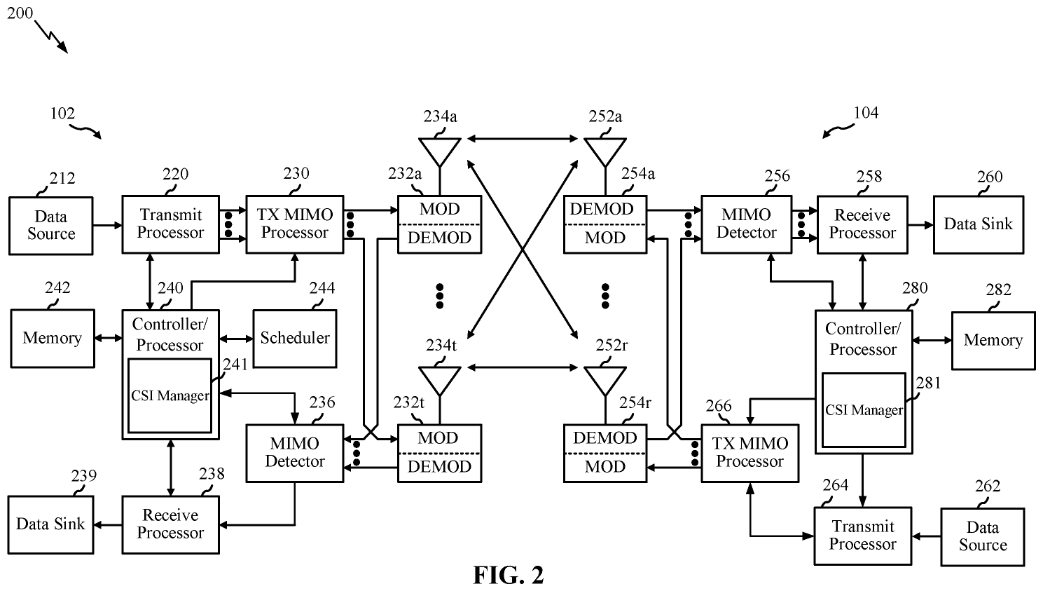

FIG. 2 depicts certain example aspects of a BS 102 and a UE 104. As with FIG. 1, FIG. 2 is briefly introduced here for context and additional aspects of FIG. 2 are described below.

Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., source data 212) and wireless reception of data (e.g., data sink 239). For example, BS 102 may send and receive data between itself and UE 104.

BS 102 includes controller/processor 240, which may be configured to implement various functions related to wireless communications. In the depicted example, controller/processor 240 includes SSB indication component 241, which may be representative of SSB indication component 199 of FIG. 1. Notably, while depicted as an aspect of controller/processor 240, SSB indication component 241 may be implemented additionally or alternatively in various other aspects of BS 102 in other implementations.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., source data 262) and wireless reception of data (e.g., data sink 260).

UE 104 includes controller/processor 280, which may be configured to implement various functions related to wireless communications. In the depicted example, controller/processor 280 includes SSB interpretation component 281, which may be representative of SSB interpretation component 198 of FIG. 1. Notably, while depicted as an aspect of controller/processor 280, SSB interpretation component 281 may be implemented additionally or alternatively in various other aspects of UE 104 in other implementations.

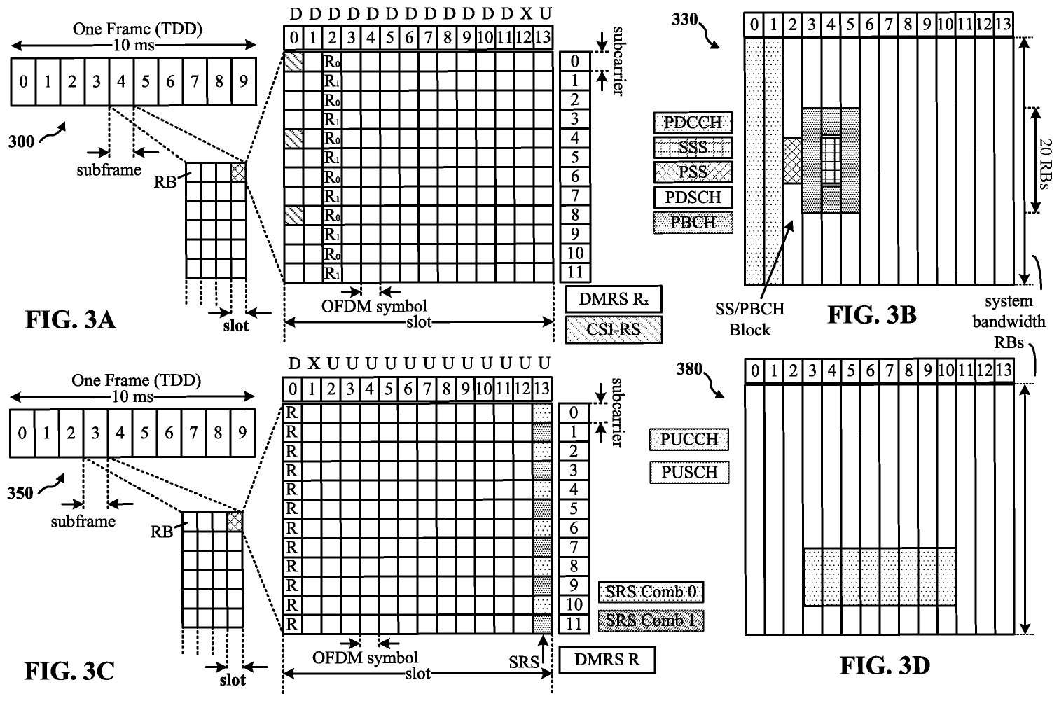

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Brief Introduction to mmWave Wireless Communications

The electromagnetic spectrum is often subdivided, based on frequency/wavelength, into various classes, bands, channels, etc. In various aspects, a frequency may also be referred to as a carrier, a subcarrier, a frequency channel, a tone, or a subband.

In 5G, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is sometimes referred to (interchangeably) as a “millimeter wave” band in documents and articles, despite being different from the extremely high frequency (EHF) band (30 GHz-300 GHz), which is identified by the International Telecommunications Union (ITU) as a “millimeter wave” band because wavelengths at these frequencies are between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

Communications using the mmW/near mmW radio frequency band (e.g., 3 GHz-300 GHz) may have higher path loss and a shorter range compared to lower frequency communications. Accordingly, in FIG. 1, mmW base station 180 may utilize beamforming 182 with the UE 104 to improve path loss and range. To do so, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

### Brief Introduction to CSI Measurement or CSI Measurement and Report Configuration

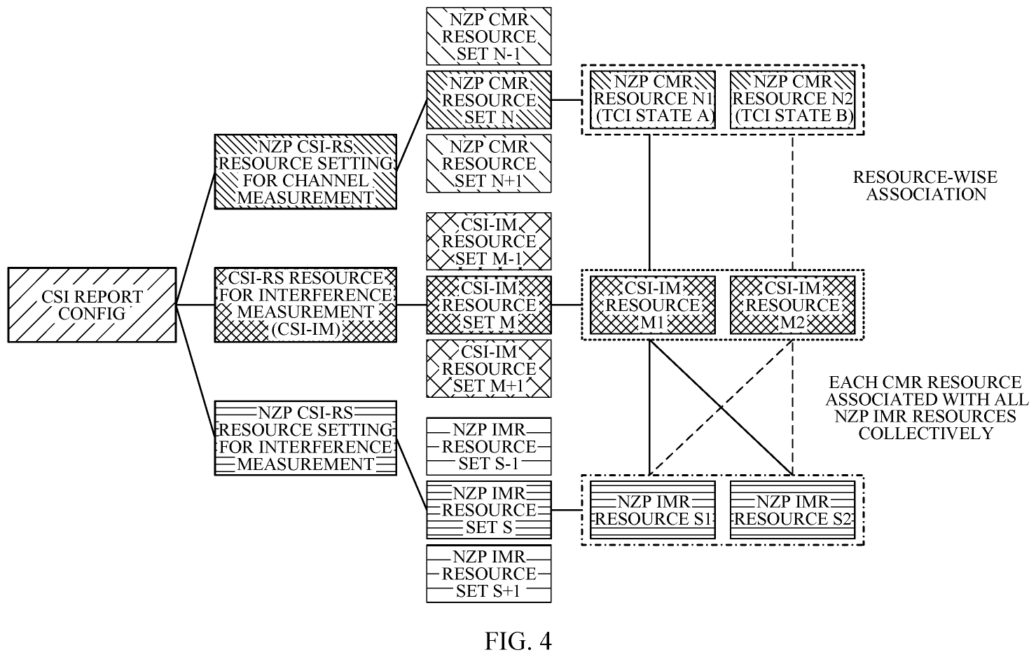

As discussed above, a UE may be configured with a CSI report configuration. FIG. 4 illustrates an example CSI report configuration. As shown in FIG. 4, the CSI report configuration may configure the UE a CMR setting, a CMR setting and CSI-IM setting, or with a CMR setting, CSI-IM setting, and NZP-IMR setting. Each setting may be associated with multiple resource sets, each resource set including multiple resources.

In some examples, the number of resources in the CMR sets may be the same as the number of resources in the CSI-IM sets, but the number of resources in the NZP-IMR sets may be different. Each resource setting may have one active set at a given time. The active set may have up to N=8 resources, and the UE may be configured to select one resource out of N configured CMRs. The CMRs may be resource-wise associated with a CSI-IM resource and NZP-IMR set.

Each port of the NZP-IMRs may correspond to an interference layer. The NZP-IMRs and the CSI-IMs may share a Type-D QCL with the associated CMR. The UE may measure interference from the interference resources associated with the selected CMR. The UE may use the interference measurements to perform interference mitigation. The CSI report configuration supports CSI for one or more TRPs.

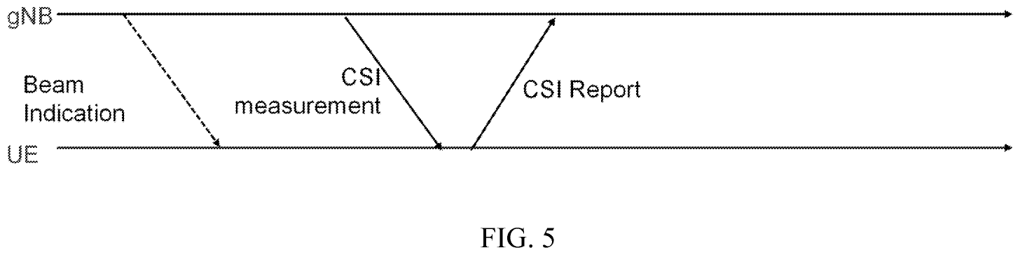

FIG. 5 is an example timeline of a network entity transmitting a beam indication and a channel state information (CSI) measurement to a UE, in aspects associated with the present disclosure. In some cases, the network entity and the UE support implicit CSI requests. As shown, the network entity transmits a beam indication that causes a CSI measurement. The UE may receive the beam indication and may subsequently perform CSI measurement or CSI measurement and report based on the beam indication.

### Example Allocation of CSI Processing Units (CPUs)

Aspects of the present disclosure provide techniques for providing CPU occupancy rules for beam indication triggered CSI measurement or CSI measurement and report. A CPU generally refers to an amount of processing overhead used for processing CSI measurement and reporting and may be considered a UE capability (and reported as such). The CPU allocation scheme described may specify reservation and release of CPUs for CSI. For example, the UE may receive an indication from a network entity configuring the UE with a number of one or more CPUs allowed to be occupied for CSI measurement or CSI measurement and report. The present disclosure provides occupancy rule for a start timing for the CPU.

According to certain aspects, a network entity may configure a number of CPUs reserved for CSI calculation. The UE may use the configured number of reserved CPUs to calculate the CSI. The reserved CPUs may be released for another reservation when certain conditions are met. For example, the UE may release the CPU after the last symbol of the configured PUSCH/PUCCH carrying the CSI report. When there is no CSI report, the network entity may assume that there is no mismatch. In this case, the number of occupied CPU reserved for CSI calculation is not transparent to the network entity.

In some cases, the UE may release the CPU when the mismatch value is less than the configured threshold (e.g., there may be little change relative to a previous report and the CPU may be released to allow for other CSI measurement/reporting). The UE may begin CSI calculation when there are unoccupied CPU reserved for CSI. The number of occupied CPU reserved for CSI may be transparent to the network. The CSI report in UL resource is expected to be the updated one. The network may monitor CSI report in the UL resource when allowing CSI. In some cases, the UE may release the CPU a number of symbols (e.g., m symbols) after starting to use the CPU to calculate CSI measurement or CSI measurement and report.

### Example CPU Occupancy

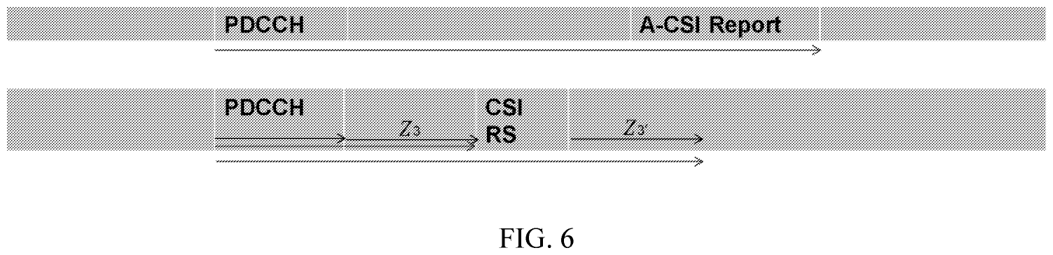

FIG. 6 is an example timeline for CSI processing unit (CPU) occupancy, in accordance with certain aspects of the present disclosure. As shown in the upper example, for a CSI report with CSI-ReportConfig with higher layer parameter reportQuantity not set to ‘none,’ the CPU(s) may be occupied for a number of OFDM symbols based on an aperiodic CSI report occupies CPU(s) from the first symbol after the PDCCH triggering the CSI report until the last symbol of the PUSCH carrying the report.

As shown in the lower example, for a CSI report with CSI-ReportConfig with higher layer parameter reportQuantity set to ‘none’ and CSI-RS-ResourceSet with higher layer parameter trs-Info not configured, the CPU(s) may be occupied for a number of OFDM symbols based on an aperiodic CSI report occupies CPU(s) from the first symbol after the PDCCH triggering the CSI report until the last symbol between Z3 symbols after the first symbol after the PDCCH triggering the CSI report and Z3′ symbols after the last symbol of the latest one of each CSI-RS/SSB resource for channel measurement for L1-RSRP computation.

Aspects of the present disclosure provide apparatuses, methods, processing systems, and computer-readable mediums for clearly associating a beam indication with a CSI measurement or CSI measurement and report, and clearly indicating when the UE may apply the CSI measurement or CSI measurement or report. In addition, it is advantageous to provide related CPU rules, such as specifying the start timing for beam indication triggered CSI measurement or report.

### Example Beam Association to Trigger CSI

FIG. 7 is a flow diagram illustrating example operations 700 for wireless communication. The operations 700 may be performed, for example, by a network entity (e.g., such as the BS 102 in the wireless communication network 100 of FIG. 1). The operations 700 may be implemented as software components that are executed and run on one or more processors (e.g., the controller/processor 240 of FIG. 2). Further, transmission and reception of signals by the network entity in operations 700 may be enabled, for example, by one or more antennas (e.g., the antennas 234 of FIG. 2). In certain aspects, the transmission and/or reception of signals by the network entity may be implemented via a bus interface of one or more processors (e.g., the controller/processor 240) obtaining and/or outputting signals.

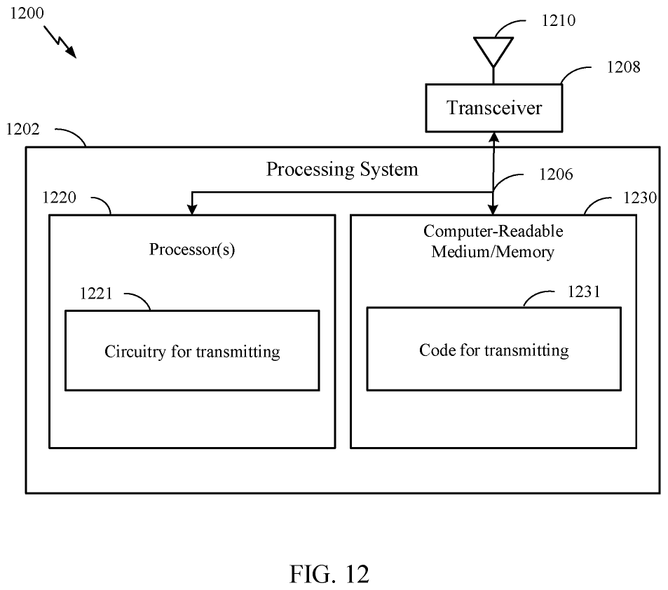

The operations 700 begin, at 710, by transmitting signaling to a UE to associate at least one beam with a channel state information (CSI) measurement or report in the UE. For example, the network entity may transmit the signaling using antenna(s) and transmitter/transceiver components of the BS 102 shown in FIG. 1 or FIG. 2 and/or of the apparatus shown in FIG. 12.

At 720, the network entity transmits a beam indication to the UE for triggering the UE to perform CSI measurement or CSI measurement and reporting associated with the beam. For example, the network entity may send the signaling using antenna(s) and transmitter/transceiver components of the BS 102 shown in FIG. 1 or FIG. 2 and/or of the apparatus shown in FIG. 12.

FIG. 8 depicts a flow diagram illustrating example operations 800 for wireless communication. The operations 800 may be performed, for example, by a UE (e.g., the UE 104 in the wireless communication network 100 of FIG. 1). The operations 800 may be implemented as software components that are executed and run on one or more processors (e.g., the controller/processor 280 of FIG. 2). Further, transmission and reception of signals by the UE in operations 800 may be enabled, for example, by one or more antennas (e.g., the antennas 252 of FIG. 2). In certain aspects, the transmission and/or reception of signals by the UE may be implemented via a bus interface of one or more processors (e.g., the controller/processor 280) obtaining and/or outputting signals.

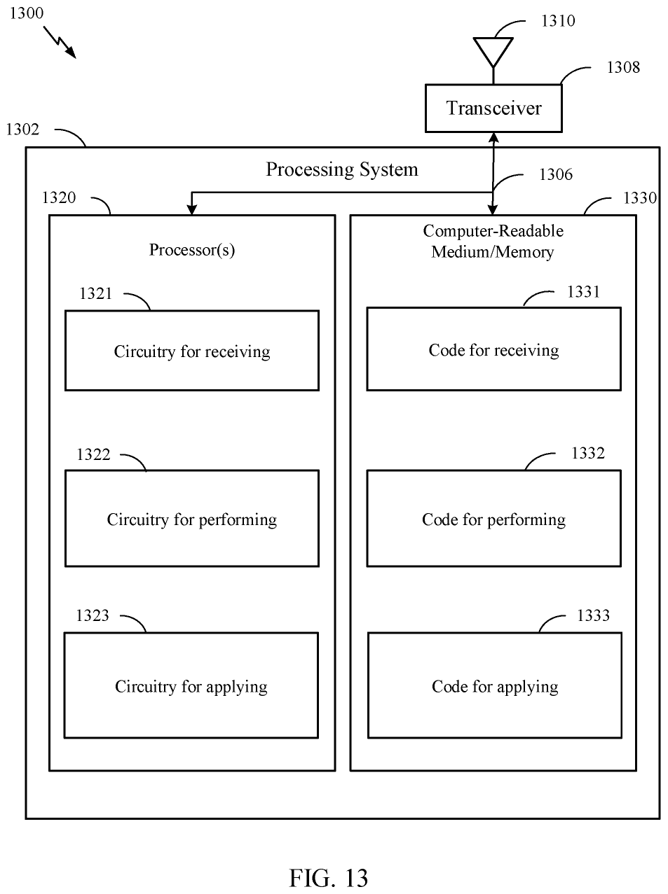

The operations 800 begin, at 810, by receiving signaling from a network entity associating at least one beam with a CSI measurement or report in the UE. For example, the UE may receive the signaling using antenna(s) and transmitter/transceiver components of the UE 104 shown in FIG. 1 or FIG. 2 and/or of the apparatus shown in FIG. 13. At 820, the UE receives, from the network entity, a beam indication from the network entity. At 830, the UE performs at least one of a CSI measurement or CSI measurement and reporting associated with a beam indicated by the beam indication.

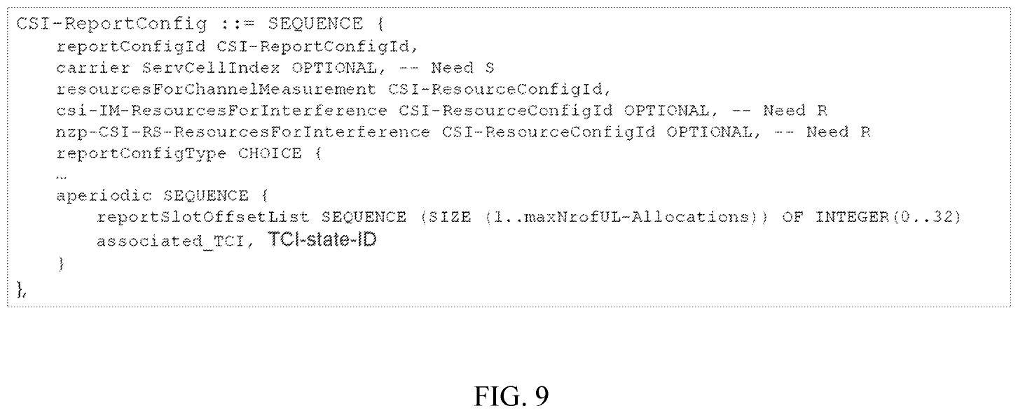

The operations 700 and 800 of FIGS. 7 and 8 may be further understood within reference to FIGS. 9-11, which illustrate various examples or options for associating beam indication with CSI measurement or report.

In certain aspects, the network entity transmits signaling to the UE by transmitting a CSI configuration with an indication of the beam. For example, the beam may be indicated in the CSI configuration by a transmission configuration indicator (TCI) identifier (ID) or TCI state ID. In some instances, the TCI ID is included in or associated with a CSI report configuration. In some instances, the TCI ID is included in or associated with a CSI triggering state. In some instances, the TCI ID is included in or associated with a codepoint of CSI request in uplink (UL) downlink control information (DCI).

In some aspects, the TCI ID may be included in the CSI report configuration, the CSI triggering state, or the codepoint of CSI request by the radio resource control (RRC) signaling. In some aspects, the TCI ID may be associated with the CSI report configuration, the CSI triggering state, or the codepoint of CSI request by the medium access control (MAC) control element (CE) or MAC-CE signaling. The MAC-CE signaling may be used to activate or deactivate the association between the ID of CSI report configuration, the CSI triggering state, or the codepoint of CSI request and the TCI ID.

An example of including the TCI state ID in the CSI report configuration is shown in FIG. 9. As shown in FIG. 9, the information element in CSI-ReportConfig may expressly include the aperiodic sequence including the TCI-state-ID.

In some cases, a TCI configuration has an associated CSI ID to enable beam indication triggering a CSI measurement and/or report. In certain aspects, the network entity transmits signaling to the UE by transmitting a TCI state with an indication of the beam. For example, the beam may be indicated in the TCI state by a CSI configuration ID. In some instances, the TCI state includes or associates with a CSI report configuration. In some instances, the TCI state includes or associates with a CSI triggering state ID. In some instances, the TCI state includes or associates with a codepoint ID of a CSI request in a UL DCI.

In some aspects, the ID of CSI report configuration, the CSI triggering state, or the codepoint of CSI request may be included in the TCI state configuration by the RRC signaling. In some other aspects, the ID of CSI report configuration, the CSI triggering state, or the codepoint of CSI request may be associated with the TCI ID by the MAC-CE signaling. The MAC-CE signaling may be used to activate or deactivate the association between the TCI ID and the CSI report configuration, the CSI triggering state, or the codepoint of CSI request.

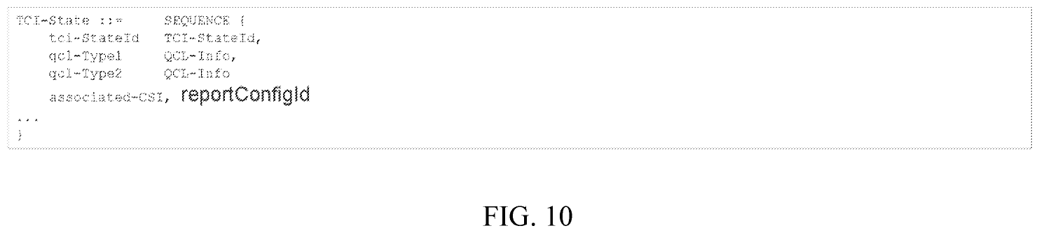

An example of including the CSI report configuration in the TCI state is shown in FIG. 10. As shown in FIG. 10, the information element in TCI-State may expressly include the CSI reportConfigId along with the associated-CSI.

In certain aspects, acknowledgement to TCI or beam indication would be supported, for example, to unified TCI indication. As such, the present disclosure provides related application condition for a CSI to be triggered by a beam indication. For example, when a UE is configured with a CSI measurement and/or report associated with a beam indication (e.g., unified TCI), the UE may apply the CSI measurement/report when the UE receives the PDCCH or PDSCH carrying the beam indication. In some instances, the UE may apply the CSI measurement/report when the UE transmits the acknowledgement (ACK) to the PDCCH or PDSCH carrying the beam indication. Given such condition, if the UE has NACK to the PDCCH or PDSCH, the UE may not apply the CSI measurement/report. In some cases, the UE may apply the CSI measurement or report only when one of the above conditions are met, namely, only when the UE receives the PDCCH or PDSCH carrying the beam indication or only when the UE transmits the ACK to the PDCCH or PDSCH carrying the beam indication.

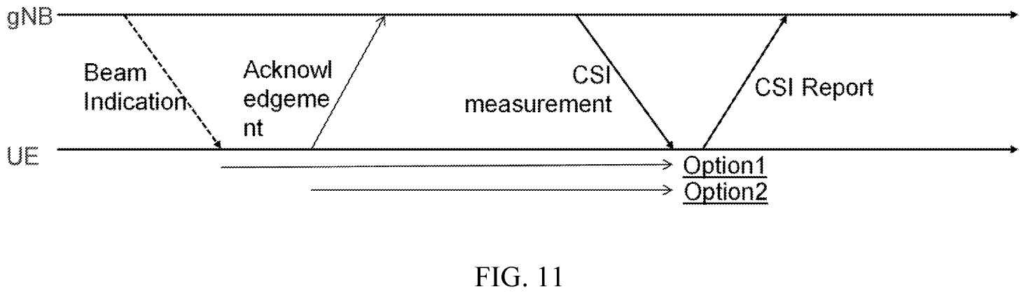

FIG. 11 is an example timeline 1100 for CSI processing unit (CPU) occupancy, in accordance with certain aspects of the present disclosure. As shown, TCI or beam indication may trigger an acknowledgement in the UE. As such, the express association between the beam indication and the CSI measurement or CSI measurement report may be used to clarify the CPU duration.

For example, when the UE is configured with a CSI measurement or CSI measurement report associated with a beam indication (e.g., unified TCI), the UE may determine the CPU occupied for the CSI based on the reference timing of the PDCCH or PDSCH carrying the beam indication. The CPU may occupy for the duration (starting at when the beam indication is received) as shown in the option 1 line in FIG. 11. In some cases, the TCI field may be carried or conveyed in DCI or MAC-CE of the TCI activation in PDSCH. For example, the CPU may occupy for the duration starting at the first symbol after the PDCCH or PDSCH reception carrying the beam indication.

In certain aspects, the UE may determine the CPU occupied for the CSI based on the acknowledgment to the PDCCH or PDSCH carrying the beam indication. The CPU may occupy for the duration (starting at when the UE sends the acknowledgement) as shown in the option 1 line in FIG. 11, e.g., the CPU may occupy for the duration starting at the first symbol after the PUCCH or PUSCH transmission carrying the acknowledgement.

In some cases, regarding example information elements implementations, for a CSI report with (SI-ReportConfig with higher layer parameter reportQuantity not set to ‘none,’ the CPU(s) may be occupied for a number of OFDM symbols based on an aperiodic CSI report occupies CPU(s) from the first symbol after the acknowledgement of the PDCCH carrying the beam indication associated with the CSI report until the last symbol of the PUSCH carrying the report.

In some cases, for a CSI report with CSI-ReportConfig with higher layer parameter reportQuantity set to ‘none’ and CSI-RS-ResourceSet with higher layer parameter trs-Info is not configured, the CPU(s) may be occupied for a number of OFDM symbols based on an aperiodic CSI report occupies CPU(s) from the first symbol after the acknowledgement of the PDCCH associated with the beam indication for triggering the CSI report until the last symbol between Z₃ symbols after the first symbol after the PDCCH triggering the CSI report and Z₃′ symbols after the last symbol of the latest one of each CSI-RS/SSB resource for channel measurement for L1-RSRP computation.

### Example Wireless Communication Devices

FIG. 12 depicts an example communications device 1200 that includes various components operable, configured, or adapted to perform operations for the techniques disclosed herein, such as the operations depicted and described with respect to FIG. 7. In some examples, communication device 1200 may be a base station (BS) 102 as described, for example with respect to FIGS. 1 and 2.

Communications device 1200 includes a processing system 1202 coupled to a transceiver 1208 (e.g., a transmitter and/or a receiver). Transceiver 1208 is configured to transmit (or send) and receive signals for the communications device 1200 via an antenna 1210, such as the various signals as described herein. Processing system 1202 may be configured to perform processing functions for communications device 1200, including processing signals received and/or to be transmitted by communications device 1200.

Processing system 1202 includes one or more processors 1220 coupled to a computer-readable medium/memory 1220 via a bus 1206. In certain aspects, computer-readable medium/memory 1220 is configured to store instructions (e.g., computer-executable code) that when executed by the one or more processors 1220, cause the one or more processors 1220 to perform the operations illustrated in FIG. 7, or other operations for performing the various techniques discussed herein.

In the depicted example, computer-readable medium/memory 1230 stores code 1231 for transmitting.

In certain aspects, the code 1231 for transmitting includes code for transmitting signaling to a user equipment (UE) to associate at least one beam with a channel state information (CSI) measurement or report in the UE, and/or code for transmitting a beam indication to the UE for triggering the UE to perform CSI measurement or CSI measurement and reporting associated with the beam.

In the depicted example, the one or more processors 1220 include circuitry configured to implement the code stored in the computer-readable medium/memory 1220, including circuitry 1221 for transmitting.

In certain aspects, the circuitry 1221 for transmitting includes circuitry for transmitting signaling to a user equipment (UE) to associate at least one beam with a channel state information (CSI) measurement or report in the UE, and/or circuitry for transmitting a beam indication to the UE for triggering the UE to perform CSI measurement or CSI measurement and reporting associated with the beam.

Various components of communications device 1200 may provide means for performing the methods described herein, including with respect to FIG. 7.

In some examples, means for transmitting or sending (or means for outputting for transmission) may include the transceivers 232 and/or antenna(s) 234 of the BS 102 illustrated in FIG. 2 and/or transceiver 1208 and antenna 1210 of the communication device 1200 in FIG. 12.

In some examples, means for receiving (or means for obtaining) may include the transceivers 232 and/or antenna(s) 234 of the BS 102 illustrated in FIG. 2 and/or transceiver 1208 and antenna 1210 of the communication device 1200 in FIG. 12.

In some examples, means for transmitting signaling to a user equipment (UE) to associate at least one beam with a channel state information (CSI) measurement or report in the UE; and means for transmitting a beam indication to the UE for triggering the UE to perform CSI measurement or CSI measurement and reporting associated with the beam may include various processing system components, such as: the one or more processors 1220 in FIG. 12, or aspects of the user equipment 104 depicted in FIG. 2, including receive processor 258, transmit processor 264, TX MIMO processor 266, and/or controller/processor 280 (including SSB interpretation component 281).

Notably, FIG. 12 is just use example, and many other examples and configurations of communication device 1200 are possible.

FIG. 13 depicts an example communications device 1300 that includes various components operable, configured, or adapted to perform operations for the techniques disclosed herein, such as the operations depicted and described with respect to FIG. 8. In some examples, communication device 1300 may be a UE 104 as described, for example with respect to FIGS. 1 and 2.

Communications device 1300 includes a processing system 1302 coupled to a transceiver 1308 (e.g., a transmitter and/or a receiver). Transceiver 1308 is configured to transmit (or send) and receive signals for the communications device 1300 via an antenna 1310, such as the various signals as described herein. Processing system 1302 may be configured to perform processing functions for communications device 1300, including processing signals received and/or to be transmitted by communications device 1300.

Processing system 1302 includes one or more processors 1320 coupled to a computer-readable medium/memory 1320 via a bus 1306. In certain aspects, computer-readable medium/memory 1320 is configured to store instructions (e.g., computer-executable code) that when executed by the one or more processors 1320, cause the one or more processors 1320 to perform the operations illustrated in FIG. 8, or other operations for performing the various techniques discussed herein.

In the depicted example, computer-readable medium/memory 1330 stores code 1331 for receiving, code 1332 for performing, and code 1333 for applying.

In some cases, the code 1331 for receiving may include code for receiving signaling from a network entity associating at least one beam with a channel state information (CSI) measurement or report in the UE; code for receiving a beam indication from the network entity; code for receiving an indication from the network entity configuring the UE with a number of one or more CSI processing units (CPUs) allowed to be occupied for CSI measurement or report, wherein the one or more CPUs are allowed to be occupied for a period of a reference timing of a physical downlink control channel (PDCCH) or a physical downlink shared channel (PDSCH) carrying the beam indication; and/or code for receiving an indication from the network entity configuring the UE with a number of one or more CPUs allowed to be occupied for CSI measurement or report, wherein the one or more CPUs are allowed to be occupied for a period of a reference timing of an acknowledgement (ACK) to a PDCCH or a PDSCH carrying the beam indication.

In some cases, the code 1332 for performing may include code for performing at least one of a CSI measurement or CSI measurement and reporting associated with a beam indicated by the beam indication.

In some cases, the code 1333 for applying may include code for applying the CSI measurement or report when the UE receives a physical downlink control channel (PDCCH) or a physical downlink shared channel (PDSCH) carrying the beam indication; and/or code for applying the CSI measurement or report when the UE transmits an acknowledgement (ACK) to a physical downlink control channel (PDCCH) or a physical downlink shared channel (PDSCH) carrying the beam indication.

In the depicted example, the one or more processors 1320 include circuitry configured to implement the code stored in the computer-readable medium/memory 1320, including circuitry 1321 for receiving, circuitry 1322 for performing; and circuitry 1323 for applying.

In some cases, the circuitry 1321 for receiving may include circuitry for receiving signaling from a network entity associating at least one beam with a channel state information (CSI) measurement or report in the UE; circuitry for receiving a beam indication from the network entity; circuitry for receiving an indication from the network entity configuring the UE with a number of one or more CSI processing units (CPUs) allowed to be occupied for CSI measurement or report, wherein the one or more CPUs are allowed to be occupied for a period of a reference timing of a physical downlink control channel (PDCCH) or a physical downlink shared channel (PDSCH) carrying the beam indication; and/or circuitry for receiving an indication from the network entity configuring the UE with a number of one or more CPUs allowed to be occupied for CSI measurement or report, wherein the one or more CPUs are allowed to be occupied for a period of a reference timing of an acknowledgement (ACK) to a PDCCH or a PDSCH carrying the beam indication.

In some cases, the circuitry 1322 for performing may include circuitry for performing at least one of a CSI measurement or CSI measurement and reporting associated with a beam indicated by the beam indication.

In some cases, the circuitry 1323 for applying may include circuitry for applying the CSI measurement or report when the UE receives a physical downlink control channel (PDCCH) or a physical downlink shared channel (PDSCH) carrying the beam indication; and/or circuitry for applying the CSI measurement or report when the UE transmits an acknowledgement (ACK) to a physical downlink control channel (PDCCH) or a physical downlink shared channel (PDSCH) carrying the beam indication.

Various components of communications device 1300 may provide means for performing the methods described herein, including with respect to FIG. 8.

In some examples, means for transmitting or sending (or means for outputting for transmission) may include the transceivers 254 and/or antenna(s) 252 of the UE 104 illustrated in FIG. 2 and/or transceiver 1308 and antenna 1310 of the communication device 1300 in FIG. 13.

In some examples, means for receiving (or means for obtaining) may include the transceivers 254 and/or antenna(s) 252 of the UE 104 illustrated in FIG. 2 and/or transceiver 1308 and antenna 1310 of the communication device 1300 in FIG. 13.

In some examples, means for receiving signaling from a network entity associating at least one beam with a CSI measurement or report in the UE; means for receiving a beam indication from the network entity, means for receiving an indication configuring the UE with one or more CPUs allowed to be occupied; means for performing at least one of a CSI measurement or CSI measurement and reporting associated with a beam indicated by the beam indication; means for applying the CSI measurement or report when the UE receives a PDCCH or a PDSCH carrying the beam indication; and/or means for avoiding applying the CSI measurement or report when the UE transmits a negative acknowledgement (NACK) to the PDCCH or the PDSCH may include various processing system components, such as: the one or more processors 1320 in FIG. 13, or aspects of the BS 102 depicted in FIG. 2, including receive processor 238, transmit processor 220, TX MIMO processor 230, and/or controller/processor 240 (including SSB indication component 241).

Notably, FIG. 13 is just use example, and many other examples and configurations of communication device 1300 are possible.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmW), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with core network 190 through second backhaul links 184. Base stations 102 may communicate directly or indirectly (e.g., through the EPC 160 or core network 190) with each other over third backhaul links 134 (e.g., ×2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152 / AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

Core network 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and core network 190. Generally, AMF 192 provides QoS flow and session management.

All user Internet protocol (IP) packets are transferred through UPF 195, which is connected to the IP Services 197, and which provides UE IP address allocation as well as other functions for core network 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

Antennas 252, processors 266, 258, 264, and/or controller/processor 280 of UE 104 and/or antennas 234, processors 220, 230, 238, and/or controller/processor 240 of BS 102 may be used to perform the various techniques and methods described herein.

For example, as shown in FIG. 2, the controller/processor 240 of the BS 102 has SSB indication component 241 that may be configured to perform the operations shown in FIG. 7, as well as other operations described herein for providing power control parameters for channels and/or reference signals sharing a same common TCI state. As shown in FIG. 2, the controller/processor 280 of the UE 104 has an SSB interpretation component 281 that may be configured to perform the operations shown in FIG. 8, as well as other operations described herein for receiving power control parameters for channels and/or reference signals sharing a same common TCI state. Although shown at the controller/processor, other components of UE 104 and BS 102 may be used to perform the operations described herein.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of power control parameters for uplink channels and/or reference signals sharing a same common TCI state in communication systems. Changes may be made in the function and arrangement of elements discussed without departing from the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another. In other words, unless a specific order of steps or actions is specified, the order and/or use of specific steps and/or actions may be modified.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor).

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above can also be considered as examples of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 7 and 8, as well as other operations described herein for providing/receiving power control parameters for channels and/or reference signals sharing a same common TCI state.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated herein. Various modifications, changes and variations may be made in the arrangement, operation, and details of the methods and apparatus described herein.

What is claimed is:

1. A method for wireless communications by a network entity, comprising:
transmitting signaling to a user equipment (UE) to associate at least one beam with a channel state information (CSI) measurement or report in the UE; and
transmitting a beam indication to the UE for triggering the UE to perform CSI measurement or CSI measurement and reporting associated with the beam.

2. The method of claim 1, wherein transmitting signaling to the UE comprises transmitting a CSI configuration with an indication of the beam.

3. The method of claim 2, wherein the beam is indicated in the CSI configuration by a transmission configuration indicator (TCI) identifier (ID).

4. The method of claim 3, wherein the TCI ID is at least one of:
included in or associated with a CSI report configuration;
included in or associated with a CSI triggering state; or
included in or associated with a codepoint of CSI request in uplink (UL) downlink control information (DCI).

5. The method of claim 1, wherein transmitting signaling to the UE comprises transmitting a transmission configuration indicator (TCI) state with an indication of the beam.

6. The method of claim 5, wherein the beam is indicated in the TCI state by a CSI configuration ID.

7. The method of claim 6, wherein the TCI state includes or associates with at least one of:
a CSI report configuration;
a CSI triggering state ID; or
a codepoint ID of a CSI request in an uplink (UL) downlink control information (DCI).

8. The method of claim 1, further comprising:
transmitting an indication to the UE for configuring the UE with a number of one or more CSI processing units (CPUs) allowed to be occupied for CSI measurement or report, wherein the one or more CPUs are allowed to be occupied for a period of a reference timing of a physical downlink control channel (PDCCH) or a physical downlink shared channel (PDSCH) carrying the beam indication. 9 The method of claim 1, further comprising:
transmitting an indication to the UE for configuring the UE with a number of one or more CSI processing units (CPUs) allowed to be occupied for CSI measurement or report, wherein the one or more CPUs are allowed to be occupied for a period of a reference timing of an acknowledgement (ACK) to a physical downlink control channel (PDCCH) or a physical downlink shared channel (PDSCH) carrying the beam indication.

10. A method for wireless communications by a user equipment (UE), comprising:
receiving signaling from a network entity associating at least one beam with a channel state information (CSI) measurement or report in the UE;
receiving a beam indication from the network entity; and
performing at least one of a CSI measurement or CSI measurement and reporting associated with a beam indicated by the beam indication.

11. The method of claim 10, wherein receiving signaling from the network entity comprises receiving a CSI configuration with an indication of the beam.

12. The method of claim 11, wherein the beam is indicated in the CSI configuration by a transmission configuration indicator (TCI) identifier (ID).

13. The method of claim 12, wherein the TCI ID is at least one of:
included in or associated with a CSI report configuration;
included in or associated with a CSI triggering state; or
included in or associated with a codepoint of CSI request in uplink (UL) downlink control information (DCI).

14. The method of claim 10, wherein receiving signaling from the network entity comprises receiving a transmission configuration indicator (TCI) state with an indication of the beam.

15. The method of claim 14, wherein the beam is indicated in the TCI state by a CSI configuration ID.

16. The method of claim 15, wherein the TCI state includes or associates with at least one of:
a CSI report configuration;
a CSI triggering state ID; or
a codepoint ID of a CSI request in an uplink (UL) downlink control information (DCI).

17. The method of claim 10, further comprising applying the CSI measurement or report when the UE receives a physical downlink control channel (PDCCH) or a physical downlink shared channel (PDSCH) carrying the beam indication.

18. The method of claim 10, further comprising applying the CSI measurement or report when the UE transmits an acknowledgement (ACK) to a physical downlink control channel (PDCCH) or a physical downlink shared channel (PDSCH) carrying the beam indication.

19. The method of claim 18, further comprising avoiding applying the CSI measurement or report when the UE transmits a negative acknowledgement (NACK) to the PDCCH or the PDSCH.

20. The method of claim 10, further comprising:
receiving an indication from the network entity configuring the UE with a number of one or more CSI processing units (CPUs) allowed to be occupied for CSI measurement or report, wherein the one or more CPUs are allowed to be occupied for a period of a reference timing of a physical downlink control channel (PDCCH) or a physical downlink shared channel (PDSCH) carrying the beam indication.

21. The method of claim 10, further comprising:
receiving an indication from the network entity configuring the UE with a number of one or more CSI processing units (CPUs) allowed to be occupied for CSI measurement or report, wherein the one or more CPUs are allowed to be occupied for a period of a reference timing of an acknowledgement (ACK) to a physical downlink control channel (PDCCH) or a physical downlink shared channel (PDSCH) carrying the beam indication.

22. An apparatus for wireless communications by a user equipment (UE), comprising:
a memory; and
a processor coupled with the memory, the memory and the processor configured to:
receive signaling from a network entity associating at least one beam with a channel state information (CSI) measurement or report in the UE;
receive a beam indication from the network entity; and
perform at least one of a CSI measurement or CSI measurement and reporting associated with a beam indicated by the beam indication.

23. The apparatus of claim 22, wherein the memory and the processor are configured to receive signaling from the network entity by receiving a CSI configuration with an indication of the beam.

24. The apparatus of claim 23, wherein the beam is indicated in the CSI configuration by a transmission configuration indicator (TCI) identifier (ID).

25. The apparatus of claim 24, wherein the TCI ID is at least one of:
included in or associated with a CSI report configuration;
included in or associated with a CSI triggering state; or
included in or associated with a codepoint of CSI request in uplink (UL) downlink control information (DCI).

26. The apparatus of claim 22, wherein the memory and the processor are configured to receive signaling from the network entity by receiving a transmission configuration indicator (TCI) state with an indication of the beam.

27. The apparatus of claim 26, wherein the beam is indicated in the TCI state by a CSI configuration ID.

28. The apparatus of claim 27, wherein the TCI state includes or associates with at least one of:
a CSI report configuration;
a CSI triggering state ID; or
a codepoint ID of a CSI request in an uplink (UL) downlink control information (DCI).

29. The apparatus of claim 22, wherein the memory and the processor are further configured to apply the CSI measurement or report when the UE receives a physical downlink control channel (PDCCH) or a physical downlink shared channel (PDSCH) carrying the beam indication.

30. A non-transitory computer readable medium storing instructions that when executed by a user equipment (UE) cause the UE to:
receive signaling from a network entity associating at least one beam with a channel state information (CSI) measurement or report in the UE;
receive a beam indication from the network entity; and
perform at least one of a CSI measurement or CSI measurement and reporting associated with a beam indicated by the beam indication.
